(19) United States
(12) Patent Application Publication
(10) Pub. No.: US 2007/0192242 A1
(43) Pub. Date: Aug. 16, 2007

(54) System and method for credit risk detection and monitoring

(76) Inventor: Reto Kunz, Monchaltdorf (CH)

Correspondence Address: PAUL, HASTINGS, JANOFSKY & WALKER LLP, P.O. BOX 919092, SAN DIEGO, CA, 92191-9092, US

(21) Appl. No.: 11/653,907

(22) Filed: Jan. 17, 2007

Related U.S. Application Data
(60) Provisional application No. 60/759,590, filed on Jan. 18, 2006.

(51) Int. Cl. G06Q 40/00

(52) U.S. Cl. 705/38

(57) ABSTRACT

A method for credit risk evaluation includes receiving a set of credit related data associated with a client. Risk events are detected from this set of credit related data according to preset rules, and a set of thresholds and filters is applied to determine whether each detected risk event is to be alerted or not. A risk event qualifying for being alerted can be directly alerted to a client advisor associated with the client. A first answer from the client advisor is received concerning the reported risk event. A response date is set for the alerted risk event. If the risk event persists at the response date, the client advisor is re-alerted as to the risk event according to the set rules.

This application claims priority to U.S. Provisional Patent Application No. 60/759,590, filed Jan. 18, 2006, which is incorporated by reference herein in its entirety.

### BACKGROUND

1. Field of the Invention

The present invention relates generally to tools for managing credit. More specifically, the present invention relates to a system and method operating in the context of an integrated system that allows continual monitoring of collateral to detect risk events.

2. Background of the Invention

As financial institutions such as banks grow larger, effective monitoring and management of risk events due to higher asset and credit volume become increasingly important. In some instances, financial institutions incorporate a wide variety of practices and technologies, extending over dispersed geographical locations in which institutional regulations vary widely. This is particularly true of multinational financial institutions operating in a plurality of jurisdictions.

One challenge is to monitor processes in an effective manner in a business environment in which varying regulatory, legal, technical and resource restrictions exist.

A further important issue is the fact that conventional monitoring systems are in general implemented locally as a fat client with many site specific variations. These systems require considerable technical support resources for each site, which can result in delaying deployments of system upgrades.

### BRIEF SUMMARY OF THE INVENTION

The present invention provides an integrated system that allows continual monitoring of collateral to detect risk events. Within this context, the system and method of the present inventions filter out technical excess and then forward true risk events directly to client advisor. Risk events above a certain threshold are forwarded immediately, while risk events below the threshold are stored and forwarded either on a periodic basis or with the risk event when the threshold or other additional filter criteria is exceeded.

In one embodiment of the present invention, a credit monitoring tool is configured to operate as a global system for credit risk monitoring in a multinational financial institution operating in a plurality of jurisdictions, where the financial institution holds loans against which collateral is pledged. The financial institution has access to data records storing information including a loan identification (ID), client ID associated with each loan ID, collateral associated with each loan ID, a client advisor associated with each client ID, and jurisdiction information associated with each client ID. A common set of monitoring processes are implemented for credit transactions spanning a region, such as a geographical region or the entire globe. In one variant, a wide range of processes, including certain non-monitoring functions such as facility and collateral management are included in the monitoring tool. In one variant, the credit monitoring tool is a web-based system that provides access at dispersed geographic locations throughout the regions in which business is conducted.

In one embodiment of the present invention, a credit risk management system is configured to detect credit risk events. The monitoring tool is configured to receive and store local credit risk related data (assets, liabilities, derivative margins, market value, haircut, lending value, etc.) received from interfacing systems at a central and/or regional hub. In one variant, the credit risk related data is received on a daily basis (though it is possible that some or all such data could be received in “real time”). Once credit risk related data is received, credit risk event determination (detection) can be performed by an engine based on credit risk criteria. In one embodiment of the present invention, the monitoring system is configured to directly alert a client advisor when a credit risk event is determined based on local credit risk data received regarding a client of the client advisor.

The information technology based system of the inventions is preferably part of an integrated system that allows continual or periodic monitoring of collateral in connection with exposure and limits to detect excess, filter out technical excesses and then forward true risk events directly to client advisor. Risk events above a certain threshold are forwarded immediately, while risk events below the threshold are stored and forwarded either on a periodic basis or with the risk event when the threshold is exceeded as described more fully below. In one embodiment of the present invention, a method for credit risk management comprises receiving local credit data concerning clients at a central storage hub, storing, at the central storage hub, local credit risk related data based on the credit data report, determining a risk event based on the stored local credit risk related data and a credit risk criterion, applying a threshold or filter condition to the risk event to determine if the risk event is to be alerted, if the threshold or filter condition is met, forwarding information concerning the determined risk event to a client advisor associated with the client, and providing a risk evaluation and risk reducing measures to a monitorer/credit officer based on input from the client advisor concerning the determined risk event.

In another embodiment of the present invention, a method for credit risk evaluation comprises receiving, at a central storage hub, local credit data concerning a client, storing, at the central storage hub, local credit risk related data based on the local credit data report, determining a risk event based on the stored local credit risk related data and a set of credit risk criteria, alerting the determined risk event to a client advisor associated with the client, providing a risk evaluation and risk reducing measures to a monitorer/credit officer based on input received from the client advisor concerning the alerted risk event, and updating the set of credit risk criteria based on the risk evaluation received from the client advisor.

An important aspect of the present invention improves the data quality associated with credit risk monitoring so that as few risk event excesses are reported to client advisors as possible, to enable client advisors to focus on other client needs. In this manner, the present invention separates risk events into technical excesses, which do not require action by a client advisor, and real excesses, which do require action by a client adviser. The technical excesses, which are typically due to system limitations and pending transactions, are discarded. The real excesses are further evaluated, and if determined to satisfy a predetermined reporting limit (e.g., greater than a threshold dollar amount), are reported immediately to the client adviser. If a real excess does not satisfy the predetermined reporting limit, the real excess data is stored and is forwarded to the client adviser periodically for the client adviser's reference, or is reported to the client adviser with a risk event that does satisfy the predetermined reporting limit.

In the case of a real excess, after reporting the real excess to the client adviser, the client adviser evaluates the real excess and provides an answer that delineates the action to be taken to address the real excess risk event. The client adviser's answer is stored and forwarded to monitoring, which assesses and approves the answer, as appropriate. An embodiment of the present invention provides this reporting between the system, the client adviser, and monitoring in an integrated workflow tool that enables the participants to embed comments within the risk event reports. In this manner, for example, the client adviser's answer can be embedded within a real excess risk event and transmitted to monitoring, instead of using separate means of communication, such as email. The risk event, the communications associated with the risk event, and the details of the resolution of the risk event can be stored in a central/regional location, to provide a convenient means for auditing past risk events.

A further aspect of the present invention capitalizes on the stored risk event data trails by identifying patterns in alleged real excess risk events that rarely result in true credit risks, and adjusting either the predetermined threshold reporting criteria or the criteria that separate technical excesses from real excesses. In a further aspect, the system counts the days in excess, beginning at a time when a real excess is detected. Once a risk event is reinstated with an OK status (i.e., the excess does not exist anymore), the system closes the event and keeps a log showing the total amount of days the excess existed. This log provides valuable data for improving the reporting criteria of the system.

Another aspect of the present invention provides dynamic and automated re-valuation of pledged assets (i.e., collateral). In providing a single worldwide system of credit risk monitoring, the invention stores a client's collateral value of assets in a central global data warehouse. The lending value of these underlying assets can then be continually and automatically calculated. These lending values and market values of pledged assets can then be used in risk detection calculations.

In providing a global credit monitoring system, an aspect of the present invention incorporates data anonymization to comply with privacy laws applicable to countries in which the local branches operate. Such laws typically provide that client names and account identifications cannot be transmitted out of the country in clear text, to avoid identification of a client. Therefore, the system anonymizes data (i.e., strips client identification data) before it leaves the country of origin and, in turn, enriches the data (i.e., inserts client identification data) when the anonymized data enters the country of origin. In this embodiment, therefore, the risk event calculations are performed on centrally stored anonymized data, rather than on non-anonymized data in each individual country. The central storage and processing of the data enables a larger body of data from which patterns can be identified, to further improve the identification of technical excesses, real excesses, and the threshold criteria for reporting real excesses (e.g., indicating real excess credit risk events that should be reclassified as technical excesses). In addition, the central storage and processing enables the evaluation of clients whose operations and pledged assets exist in multiple countries.

### BRIEF DESCRIPTION OF THE DRAWINGS

FIG. 1a is a schematic diagram that illustrates exemplary features involved in credit risk monitoring tool arranged in accordance with one embodiment of the present invention.

FIG. 1b is a schematic diagram that illustrates an exemplary credit risk monitoring system for storing credit risk event data as anonymized data, according to one embodiment of the present invention.

FIG. 1c illustrates further features of the monitoring system of FIG. 1b, according to an embodiment of the present invention.

FIG. 2 is a schematic diagram of a reference process that is used to clarify aspects of the current invention.

FIG. 3 is a schematic diagram that illustrates a comparison of risk event management in a reference process to a streamlined process that is arranged according to an embodiment of the present invention.

FIG. 4 is a schematic diagram that illustrates details of a credit monitoring system, in accordance with another embodiment of the present invention.

FIG. 5a is a flow chart that illustrates exemplary steps involved in a method of credit monitoring according to another embodiment of the present invention.

FIG. 5b illustrates exemplary substeps of the method of FIG. 5a, in accordance with one embodiment of the present invention.

FIG. 5c is a schematic diagram that illustrates an exemplary window format in which risk event information is displayed, according to one embodiment of the present invention.

FIG. 5d is a schematic diagram that depicts information provided in various monitoring views and the relation of the monitoring information to the process steps employed by a credit monitoring system in monitoring a risk event, according to an embodiment of the present invention.

FIG. 6 illustrates exemplary steps involved in a method of credit monitoring according to another embodiment of the present invention.

### DETAILED DESCRIPTION

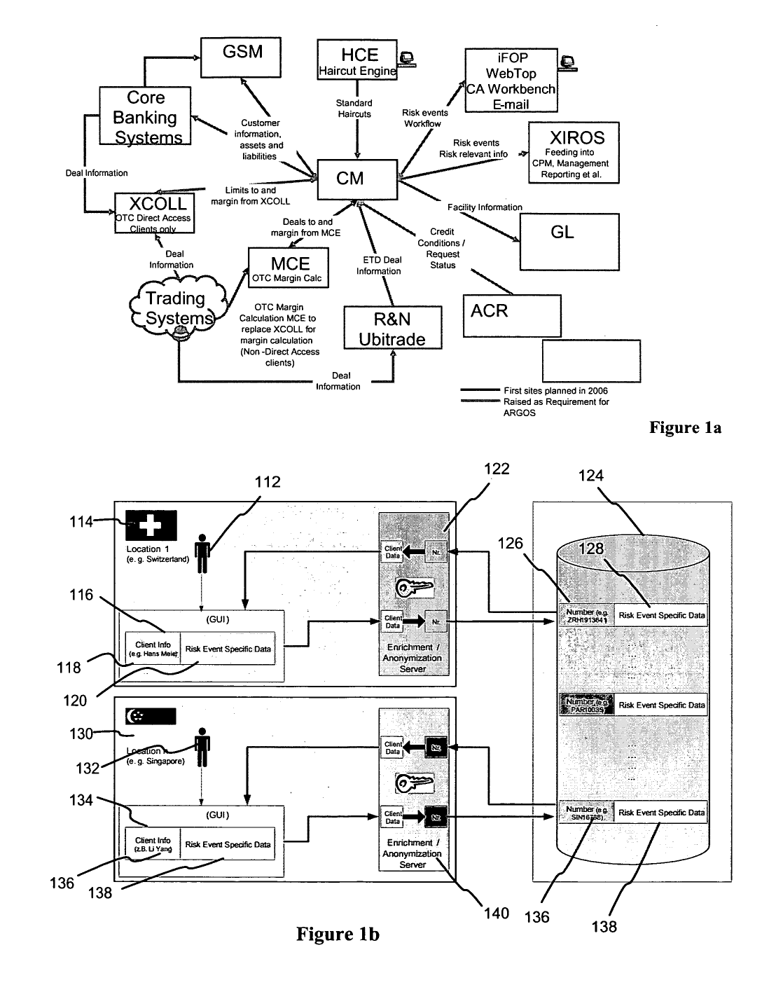

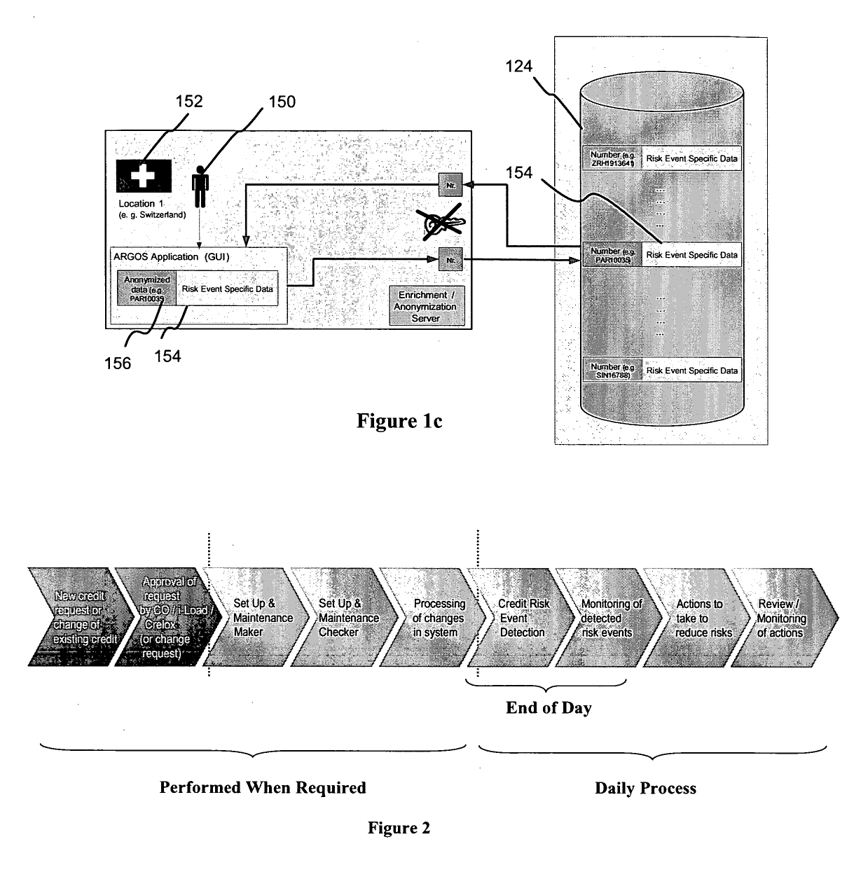

FIG. 1a is a schematic diagram that illustrates exemplary features involved in a credit risk monitoring tool arranged in accordance with one embodiment of the present invention. In accordance with different embodiments of the present invention, the credit monitoring tool CM can be linked to some or all of the entities depicted in FIG. 1a.

Credit monitor system CM (also referred to as a credit monitoring system) can perform such functions as collecting daily data (e.g., assets, liabilities, derivative margins, market value, haircut (required percentage deducted from the prevailing collateral market value), and lending value) from interfacing systems, such as a database with a globally valid data model (GSM); local banking systems used for maintenance of client data (Core Banking); over the counter derivative risk margin calculator for clients having direct trading access (XCOLL), over the counter derivative risk margin calculator (MCE), lending value maintenance system used for calibration and daily storage of lending values of securities according to their individual market risk (HCE), client advisor workbench and e-mail systems (iFOP, Webtop, CA workbench, and E-mail); global data warehouse for credit risk relevant data (XIROS); facility maintenance systems used for setting up and maintaining credit limits (GL); exchange traded derivative (ETD) margin calculator used to deliver risk margins for ETDs (R&N Ubitrade); and ACR (automated credit request processing). Further descriptions of an ACR system can be found in the related co-pending application U.S. Provisional Application Ser. No. 60/759,542, filed Jan. 18, 2006, and its corresponding non-provisional patent application titled “System and Method For Automatic Evaluation of Credit Requests,” filed Jan. 17, 2007, U.S. application Ser. No. ______, both of which are assigned to the assignee of the present invention and are herein incorporated by reference in their entirety

Credit monitor system CM is configured to use such data to calculate and detect risk event excesses associated with a client, for example, and to notify appropriate entities, such as a client advisor (CA) and/or a credit officer (CO), whose responses can be tracked, leading to risk assessment and appropriate actions being taken.

Credit monitor system CM can be configured to operate at a regional or global level. In one configuration of the invention, CM is organized as a web-based system (that is, a system that provides web-based user interfaces) that provides standardization of processes across different geographic regions. For example, CM can employ a single platform, facilitating management of standardized credit risk processes, simplifying software adaptations.

In one configuration, credit monitor system CM is configured to store in central locations data related to credit risk (DCR). Central storage can comprise storage of region-wide data (continent, country) or storage of worldwide data. CM can be configured to only store DCR as anonymized data in order to conform to legal requirements of jurisdictions from which the data is obtained. Thus, CM may include data anonymizers linked to local sources of data that provide a central storage unit (not shown) with anonymized data.

In one configuration of the present invention, the CM system includes architecture that is configured to accept anonymized data received from a source, such as a financial institution in a country where the data originates. Anomymization removes certain private client-specific information and is often required as a compliance measure in many locations. This generally entails anonymization of data, such as risk event data or other data before data is sent from an originating source, such as an institution in one country, for use by an entity that resides in another country, such as a CO or MO associated with the CM system. In turn, the anonymized data can be enriched when transferred back to the country of origin so the users there have access to the real client data. For example, enrichment and anonymization can both take place in the same location, such as the country of origin. This anonymization/enrichment procedure can be especially useful in the case where Monitoring and/or a CO are based in a different country than the CA, who, for most situations, is likely to be located in the same area as where the client has set up a relationship with the bank or other lender associated with the CM system. As mentioned above, the CM can be configured for the central storage of client data related to credit event risks that is stored in an anonymized version within the CM system, so that a Monitor or CO in another country is presented with an anonymized version of the client data.

FIG. 1b illustrates an exemplary credit risk monitoring system 110 for storing credit risk event data as anonymized data, according to one embodiment of the present invention. User 112 in location 114 can view client record 116 that includes unanonymized client identifier 118, as well as risk data 120. Record 116 can be transmitted through enrichment/anonymization server 122 to be stored in central database 124. As depicted, location 114 may be in a first country, for example, Switzerland. Central database 124 may, for example, be located in a second country. Record 116, after passing through sever 122 is provided as anonymized record 126 in database 124. Anonymized record 126 includes anonymized risk data 128 that may be, for example, a number, rather than a client name, such as that in unanonyrnized identifier 118. This can be accomplished, for example, by configuring server 122 to assign client 112 a unique scrambled identifier. Accordingly, a monitorer accessing anonymized record 126 views the risk event data without seeing the unanonymized client identifier, such as a client name.

Similarly, user 130 in location 132 (which may be in a third country) can view an unanonymized client record 134 (associated with client 130) as unanonymized client identifier (clear text) 136 and risk data 138. However, due to processing by anonymizer/enrichment server 140, client record 134 is provided to data hub 124 as anonymized client record 134 associated with client 130, which comprises risk data 138 and anonymized client identifier 136.

FIG. 1b also illustrates that anonymizer/enrichment servers 122, 140 can enrich an anonymized client record, so that clients in locations 114, 130 can receive and view their respective records as unanonymized records 116, 134. Thus, if a client record, after being created, is only stored at a central hub as an anonymized record, the client record can still be retrieved as an unanonymized record by an authorized person, such as a client, in the appropriate location.

The system illustrated in FIG. 1b thus provides a mechanism that facilitates central storage in a single or limited number of facilities client data that is received from many geographical locations in which legal constraints may prohibit certain client information from being transmitted or viewed across borders, such as national borders.

Accordingly, as illustrated in FIG. 1c, a monitorer 150 in location 152, who accesses database 124, can only view record 154 as an anonymized record that includes anonymized client identifier 156.

In other configurations of the present invention, locally received client-related data can be further processed to protect source anonymity before storage in a central facility. For example, a client record stored in a central database may include data from and/or identifiers related to third party pledgors to the beneficiary (client). Anonymization or complete removal of third party data might be required and could be performed in a manner similar to that illustrated in FIGS. 1b, 1c for client identifier anonymization.

By standardizing credit risk monitoring processes, for example, CM provides a degree of automation that facilitates a more flexible and scalable approach that can reduce operational risks associated with manual interventions in the process and site to site variations in procedures. For example, in international financial institutions, in addition to the fact that several different monitoring systems may be in place in different locations, responsibilities of the various teams involved in the monitoring activities may vary from location to location. By providing more standardization and automation to monitoring processes, such as standardizing the role of different entities across different locations and providing anonymization of client information crossing national borders, local regulatory, legal, and technical and resource restrictions can be more easily accommodated. In addition, certain non-monitoring functions such as facility and collateral management can be incorporated into the system.

FIG. 2 is a schematic diagram of a reference process that is used to clarify aspects of the current invention. FIG. 2 illustrates in particular, different steps that can be performed in the process of setting up and monitoring a loan to a client. After receiving a credit request and approval, on an as-needed basis the set up and maintenance of a client structure, third party assets, facilities, and lending value exceptions can be performed, as well as changes to the system.

Credit monitoring depends on the conditions laid out in the credit request that needs to be approved before a loan is paid out. A credit request precedes the credit monitoring and all processes that are related to the set up and maintenance of the credit contract.

On a daily basis, credit risk detection can be performed, as well as monitoring of detected credit risks and tracking of actions for reducing risks by means of setting review dates. In the reference process illustrated in FIG. 2, detection and system facilitation of monitoring of credit risks occurs at the end of a day.

Referring again to FIG. 1a, the CM system can receive from various interfaces to other systems the relevant client data needed to calculate credit risks. Relevant data are, e.g., market and lending values, overdraft amounts, limit amounts and the like. The CM system calculates and provides relevant information concerning, for example collateral shortfalls, limit excesses and unauthorized overdrafts. The CM system can be configured to check on the above-mentioned credit events on a daily basis by end of day, since relevant updated data can be retrieved from the interfaces at the end of each day. Rules can be allocated in the CM to determine whether, for example, a given set of collected client data constitutes a credit risk event (also termed “risk events” hereinafter). In addition, the CM system may determine an alert based on review or maturity dates, such as review on expiring lending values, facility limits, and further special credit conditions.

Based on the automated end of day calculation or review dates that can be set by the users manually, the CM can determine that threshold conditions have been met, in which case the CM is configured to alert the risk event to the appropriate party.

In one embodiment of the present invention, a credit risk monitoring system is configured to provide a more efficient process for risk event management including a process to improve the monitoring of risk events.

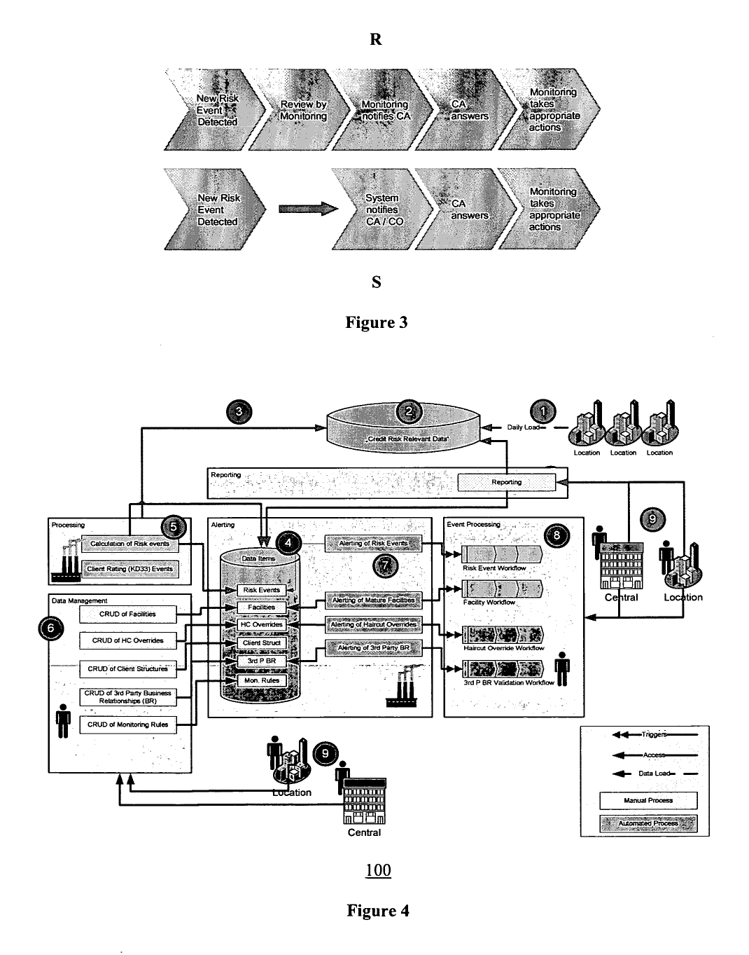

FIG. 3 illustrates a comparison of risk event management in a current reference process R, as opposed to a streamlined process S that is arranged according to an embodiment of the present invention. In both processes R and S, a new risk event is detected. Detection of a risk event can be based on rules that may define an excess attributable to a client account. In both processes, the new risk event detection may be automatically performed based on the rules.

In one example, the credit monitoring system is configured to determine that a risk event exists, for example, based on a first condition being met. The first condition might be a reported excess currency amount condition related to a client of a creditor, where an amount owed exceeds a pre-set value. When an event is detected, (for example, the daily report forwarded to a database in the CM system that shows an excess associated with the client) the credit monitoring system can verify whether the detected event requires alerting as a risk event to other entities within the creditor institution based on the use of thresholds and filters. For example, if an event is categorized as falling below a filter or threshold, it is not alerted to other entities but can be retained as accessible via a search function and for reporting purposes. A threshold parameter can be, for example, an amount of a currency excess, while a filter parameter involves both an amount of currency excess and a duration of the excess. Preferably, a log entry mentioning the applied filters/thresholds is generated for each event.

If the event exceeds the filters or thresholds, the event can be alerted as a risk event. In the process R, the newly detected risk event is reported for review by a monitoring entity or credit monitor (MO).

In one example, an MO (also referred to as “Monitoring” hereinafter) probes detected risk events associated with clients (or client accounts) of the creditor, and liaises with other entities of the creditor, such as client advisors (CA) and credit officers (CO). The MO may be a person or persons responsible for controlling risk events and reinstating a client account into an OK status. The MO may acknowledge defined actions to take with regard to a risk event, set collateral exceptions in the system and approve changes captured by the CO.

In both processes R and S, a client advisor is notified after the risk event is detected, after which notification the CA provides a response that can provide a basis for the MO to take appropriate actions. The CA has the overall responsibility for the client, including counseling the client with regard to credit requirements and offering of appropriate facilities. In most cases, a CA is located at the place in which a client holds an account. Client advisors may in general have limited credit and decision authority, so that if the authority is not sufficient for a particular request, the request is passed on to another advisor with appropriate authority or to a credit officer (CO). Credit officers typically have credit authority and generally analyze and assess credit requests and comment on critical exposures. Credit officers are also usually, but not necessarily, located where the client holds an account. COs may also be qualified to approve exceptions and update them in the system.

In one embodiment of the present invention, risk event alerting (that is, the determination that detected event is to be alerted as a risk event) is automated and standardized so that the determination is performed by a risk event calculation engine that accesses credit risk data related to a client loaded into a central facility. The determination that a risk event is to be alerted can be based on the filters and thresholds reported above. Such a system represents a standardization of a credit risk event determination process, since the same criteria (filters, thresholds) can be applied to events associated with clients that are dispersed over a wide area, and whose data is reported to a central facility.

Because the determination of risk events is standardized, the processes outlined in FIG. 3 have the potential to enhance the quality of the risk determination. Accordingly, as depicted in process S, an MO need not be assigned to review the newly detected risk event. Rather, after detection, in one configuration of the present invention, the risk event is alerted (reported) directly to a CA. The CA can then review the alerted event and provide responses to the MO.

Process S provides the advantage that the step of review by an MO of newly detected risk events can be eliminated for newly determined risk events, thus increasing the efficiency and timeliness of reporting risk events to a CA. In addition, because risk event determination is not reviewed by a person within an MO, no human filtering of the risk event determination takes place, thus eliminating human bias and variation between MO entities in the alerting of risk events to a client advisor. Humans in the MO are freed to spend more time analyzing the CA answers to determine, for example, if an OK status can be applied to the client account associated with the risk event.

FIG. 4 illustrates details of a CM system 100, in accordance with another embodiment of the present invention. System 100 (which includes elements 2-8) receives daily data load 1 from various locations 9. For example, daily load 1 may comprise daily, region-wise load transferred from locations connected to a central database in the CM system. Preferably, the transferred data is anonymized before receipt by CM system 100. Locations 9 can represent offices or branches of a creditor institution that are dispersed over a geographic area. For example, locations 9 might be different creditor offices across Europe.

Credit risk storage database 2 is configured to receive and store the entire daily load received from locations 9, for example. Preferably, Database 2 is configured to store all credit risk relevant data received from the locations 9, such that all client relevant data is stored as anonymized data, which is useful to prevent any possible deduction from the sheer data associated with the client.

Risk event calculation engine 5 is configured to perform data accesses 3 to retrieve data in credit risk storage 2 and to generate risk events (determine that a risk event exists). Calculation engine 5 is configured to generating risk events (shortfalls, limit excesses, unauthorized activities) in a fully automated process. Calculation engine 5 may also reflect client rating events, which can be used to update a client rating. Risk events can be stored in CM data entities database 4, which contains risk events, facilities, haircut overrides, client structures, 3^{rd} party business relationship assets, and monitoring rules.

Data manipulation system 6 is configured to provide a user access via a Web GUI to CM database 4, to manipulate (CRUD, i.e. Create, Read, Update and Delete) client-related features, such as facilities, haircut overrides, client structures, third party business relationships, and monitoring rules and provides this information to alerting database 4. In one embodiment of the present invention, the access to this functionality is provided for users in every location 9, while in another embodiment, access to database 4 using system 6 is limited according to access rights.

In system 7, risk events are alerted, as well as facilities, the value of 3^{rd} party assets and haircut overrides to be verified. This is a fully automated process. Each of the alerting processes feeds respective information into a workflow process.

Event processing system 8 receives, for example, alerted risk events 7 and initiates required workflows in a risk event window, which can be provided to a Monitor, or directly to a CA, for example. Moreover, event processing system 8 includes a specific workflow for each alert type. Users can access the alert-triggered workflows and view the alerted events and take appropriate actions

In one embodiment of the present invention, the credit risk monitoring tool is a web-based system that covers the wide range of monitoring processes, including certain non-monitoring functions such as facility and collateral management and improvements not reflected in the current monitoring systems. The CM can monitor on a daily basis for any excesses.

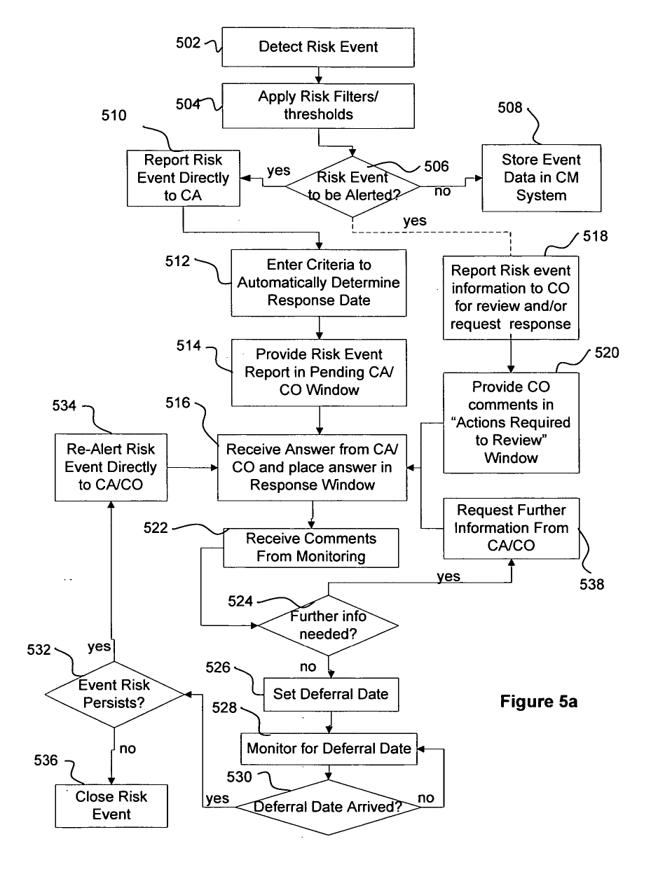

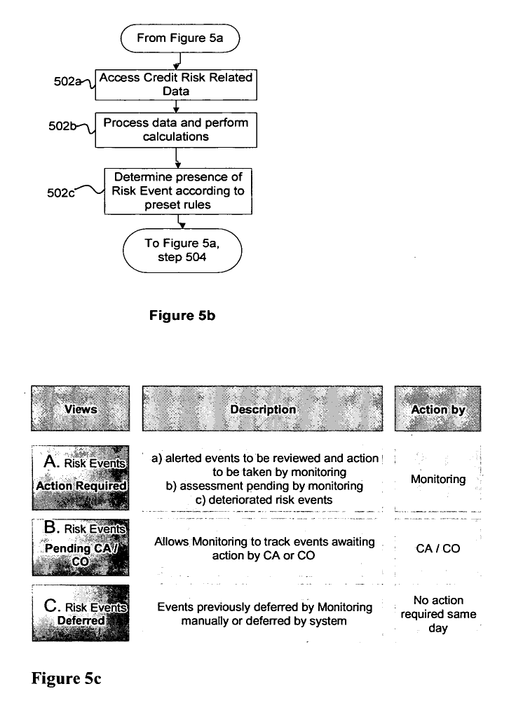

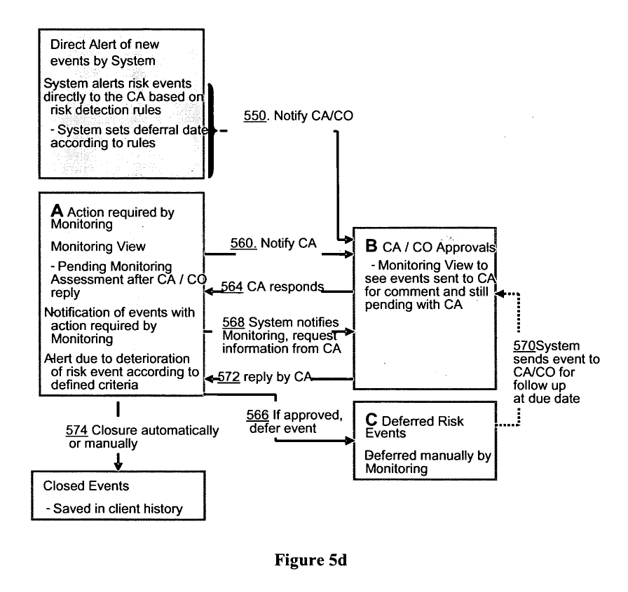

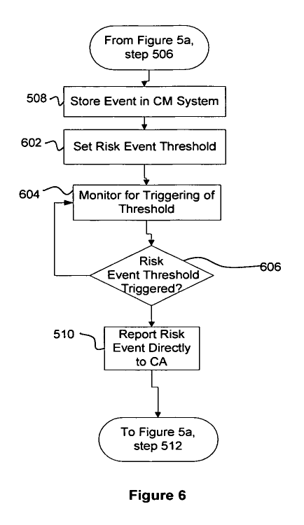

Accordingly, the CM system of FIG. 4 provides an integrated communication approach to detecting and managing credit risk events. In the first case, credit risk events can be automatically detected and alerted to an appropriate party, such as a CA (as discussed further with respect to FIGS. 5a-6 below). Second, users (such as a CA or CO) are directly linked to the CM through workflow tools that link to graphic user interfaces where credit risk event information can be displayed to a user and user comments can be entered.

In one embodiment of the present invention, the CM system can be configured to provide the functionality to set up and link different business relationships to one partner. As used herein, a partner is defined as a legal entity or legal personality. A partner may be a single private client, a joint relationship of several entities (having requested a loan via a joint account), a private investment company (such as fund or trust) or a company. A business relationship is defined as a relationship the client has with the bank and which holds the client's assets, exposures, margin requirements and/or facilities. Depending on the core system of the countries, there are different local naming conventions and structures with regard to what corresponds to a business relationship. A business relationship may, e.g., be listed as one account or a portfolio in a first country, while in another country, a business relationship comprises several accounts linked under one customer number. There are also country-specific differences that determine whether a business relationship holds pledged assets and/or non-pledged assets, the liability, or a combination of all. The set-up of the business relationship therefore varies between countries, and may be accounted for in a CM system. The linking of different business relationships to a single partner using a CM tool can group the total exposure with the collateral belonging to the same entity, providing the basis for the calculation of the risk events and the monitoring.

Another aspect of the present invention provides dynamic and automated re-valuation of pledged assets (i.e., collateral). In providing a single worldwide system of credit risk monitoring, the invention stores a client's collateral value of assets in a central global data warehouse. This valuation data can include portfolio structures with third party assets, such as life insurance policies and life insurance wrappers. The lending value of these underlying assets can then be continually and automatically calculated. For example, a daily market-to-market valuation on collateral held can be conducted to measure the sufficiency of assets pledged in terms of exposure incurred by clients. These lending values and market values of pledged assets can then be forwarded to a CM system and used in risk detection calculations.

FIG. 5a illustrates exemplary steps involved in a method of credit risk management, according to an embodiment of the present invention. In step 502, a credit risk event is detected within the CM system. For example, referring also to FIG. 4, excess amount data regarding a client (referred to as client “A” for purposes of illustration) may be reported to the CM system and stored in database 2. The CM system may determine based on preset rules that the data constitutes a credit risk event. For example, risk calculation engine 5 could retrieve daily reported data from database 2 and perform calculations to determine the presence of risk events based on the preset rules.

FIG. 5b illustrates exemplary substeps that comprise step 502, in accordance with one embodiment of the present invention. In step 502a, credit risk related data is accessed by the CM system. For example, the CM system may collect client data at the end of a business day.

In step 502b, calculations are performed on the accessed data.

In step 502c, a credit risk event is determined to be present using preset rules based on the performed calculations.

In step 504, thresholds and filters are applied to the reported data to determine whether the credit risk event qualifies as a risk event to be reported to a CA or CO.

In accordance with embodiments of the present invention, set criteria can be applied to detected credit risk events (risk events that are detected and reported within the CM system for possible alerting as risk events). In other words, not all detected credit risk events are alerted to a CA or MO to be worked on as risk events, since filtering is performed to determine risk events that do not meet certain risk event criteria, such as minimum threshold amount or minimum amount of days in excess. Risk events are thus filtered by the set filters and thresholds. Those filtered credit risk events that are deemed not to be provided to an MO can still be used as identifiable information for statistics and reporting purposes separately as filtered due to a filter or due to a threshold. Risk events filtered by the system can be entered in an automated log that is created every day.

In step 506, if the results of the filtering indicate that the event does not qualify as a risk event to be alerted, the process moves to step 508, where the event data is stored in the CM system. The stored data, for example, the excess amount of client A, is provided in a form accessible for later evaluation by MO or other entities.

If a risk event is determined to be alerted, the process moves to step 510. In step 510, the CM system sends the risk events directly to a CA.

In one embodiment of the present invention, the direct notification of the CA occurs for the first notification of a risk event. If a risk event to be notified to a CA represents an event that was previously deferred, further notification may be sent to a Monitoring facility or under specific circumstances to the CA.

When the system sends new risk events directly to the CA, in step 512 criteria are entered for the system to set a deferral (i.e., response) date for the risk events automatically. Criteria can be set according to country of origin and according to each risk event type (possibly based on amount/sum in excess in currency/days in excess for Warning, Margin Call, Close out, Limit Excess and Unauthorized Activity).

In step 514, after notification of the CA, a notation of the risk event appears in a Pending CA/CO window accessible to a Monitoring facility. The CM system is preferably configured to provide access through a graphical user interface to pending risk event information. FIG. 5c illustrates an exemplary window format in which risk event information is displayed, according to one embodiment of the present invention. FIG. 5b can represent, for example, a “Monitorer View” provided to an MO employee. FIG. 5b lists various categories of information and illustrates a schematic arrangement of the information in columns and rows. Categories of risk event information include “Action Required,” “Pending CA/CO,” and “Deferred.” The “Pending CA/CO” window provides to an MO information that indicates what risk events need input from a CA/CO. In addition, the “Action Required” window alerts the MO to actions that the MO must take. Finally, information on deferred risk events is provided in the “Deferred” window. Similar type of information can be provided over a graphical user interface to the CA and/or CO.

Additionally, a CA can be provided with a user view that contains risk event information, as described above. Necessary information to be provided to the CA concerning the risk event includes identification of a client in an excess condition, a characterization of the type of risk event, an amount in excess, etc. The CA view can also be provided with a set of pre-defined measures from which the CA can select the most appropriate ones and propose a review date when responding to an alerted risk event. Further, a text field for additional comments for the CA to provide and record background information can be included. Where a Client Advisor Assistant (CAA) assumes the role of providing information on the risk events, the CA can approve the CAA's comment before sending the event back to monitoring.

In addition to having access to the Monitoring view, a CO view can be provided with access to relevant data on a client's risk events and a field to provide comments on the risk event level.

In general, the type of information provided in a Monitoring view can be set to dynamically vary according to the status of the risk event, as described further below with respect to FIG. 5c.

In step 516, an answer from a CA is received and the response is placed in a response window accessible to a Monitoring facility.

In optional step 518, a CO is also alerted to the risk event and may return a comment. For example, in European locations, the CO may need to be informed on all risk events and risk events with priority need to be flagged. Specific rules may be provided to allow the system to determine risk events that require the priority flagging. These rules may depend, for example, on the type of risk event and its maturity in age, amount in excess and other factors; in Asia and the Americas, the CO may only need to be informed of selected events. Where required, the CO adds and sends a comment to the MO.

In step 520, if a CO comments, the comments are placed in a window for Monitoring in the “actions required to review.”

In step 522, Monitoring adds comments concerning the risk event.

In step 524, if, after review by an MO, it is determined that no further information is needed, the process moves to step 526. If further information is required, the process moves to step 538, where the CA/CO is sent a request.

In step 526, a deferral date for the risk event is set based on the information supplied to Monitoring.

In step 528, the arrival of the deferral date is monitored.

In step 530, if the deferral date has not arrived, the process reverts to step 528. If the deferral date has arrived, the process moves to step 532, where a determination is made as to whether the risk event still persists. In step 532, a CM system can apply the same criteria used to establish the presence of a risk event in step 504.

If a risk event still persists on the deferral date, the process moves to step 534, where the risk event is re-alerted to the CA and/or CO associated with the client for follow-up. The count of the number of calendar days of the risk event in excess preferably keeps continuing after being alerted to the CA again. Thus, the CA and MO are apprised of the fact that the risk event has persisted for the total time since original alerting.

If the CM system determines that the risk event is no longer present, the process moves to step 536, where the risk event is closed. Events are preferably closed automatically by the system once the OK status is re-instated. This means, for example, that each day through the end-of-day processing, a given risk event will continue on if an excess still exists, but will be closed if it is determined that an excess or other condition triggering the risk event does not exist any more. The closure can then be logged appropriately by the system.

FIG. 5d is a schematic diagram that depicts information associated with various monitoring views and the relation of the monitoring information to exemplary process steps employed by a CM in monitoring a risk event, according to an embodiment of the present invention. For clarity, corresponding process steps of the exemplary process illustrated in FIG. 5a are noted.

In step 550, the CM system can automatically notify (alert) directly a CA/CO concerning the determination of a risk event. This step corresponds to step 510 in FIG. 5a. Alternatively, in step 560, the Monitoring Entity can manually notify a CA of a determined risk event. At this point, after step 550 or 560 has been performed, CA/CO “Pending Approval” view B displays information related to risk events reported to the CA, but still awaiting comments from the CA.

After step 564, in which a response is sent from the CA to a Monitoring Entity, the “Action Required” view A can list information such as a risk event that is pending monitoring assessment after CA reply. This step corresponds to step 516 of FIG. 5a. In step 566 (corresponding to step 526 of FIG. 5a), if the reported risk event is deferred, for example, if the MO manually sets a deferral date, the deferred risk event can be displayed in exemplary “Deferred Risk Events” window C. The status of the deferred risk event may, for example, be listed as manually deferred by Monitoring.

“Action Required” view A can also list notification of events with action required by the MO, and alerts due because of deterioration of a risk event. If the system requests information from the CA in step 568, for example, the MO is alerted to request follow-up information at the due date, the request may also be displayed in CA/CO approval pending view. Alternatively, after automatically sending an event alert to the CA at the deferred due date in step 570 (corresponding to step 534 in FIG. 5a), the “CA/CO Approval” view B may display that the follow-up alert is awaiting CA action.

In step 572, a reply is received from the CA, and in step 574, the event may be closed, in which case the closed event may be saved in client history, but need not be shown in any of windows A, B, or C.

In another embodiment of the present invention, a flag is provided for clients whose risk events should not be closed automatically by the system. For example, the MO could set a flag condition manually. If the flag is subsequently deleted by the MO, the CM system will close the risk event with the next batch processing the risk event has reached OK status.

Events deferred by MO may be visible for the MO user in a separate “deferred” queue.

In one embodiment of the present invention, if a CA does not respond before the suggested deferral date, and the risk event persists to the deferral date, in addition to automatically sending a follow-up notification to the CA on the deferral date, the CM is configured to defer the event automatically by a further day maximum. Upon the second deferral, the pending CA/CO events list can be provided with the updated deferral information for review by MO. If no reply is sent on the reset deferral date, MO is then alerted in the actions required for follow-up. In one embodiment of the present invention, the CM system is configured to defer the risk event only once after the initially given deferral date.

FIG. 6 illustrates exemplary steps involved in a method of credit monitoring according to another embodiment of the present invention. The method of FIG. 6 can be better understood by reference also to FIG. 5a. In step 508, a detected event that is not determined to be a risk event to be alerted after application of system thresholds/filters is stored, as disclosed above with respect to FIG. 5a. For example, a reporting financial branch of the lending institution associated with the CM may have reported an excess amount associated with a client. The applied filters are used to determine that the reported excess does not entail a risk event to be alerted and mitigated. However, the system nevertheless stores relevant information regarding the reported event.

In step 602, an event threshold is set by the system. For example, based on the type of risk event detected, a specific type of threshold can be set. The threshold can be set dynamically, for example. If the risk event represents a certain excess, say $1 M, a risk calculation engine may be used to determine based on the facts surrounding the excess amount that a risk event will need to be alerted if the $1 M excess persist for 10 days. Thus, a threshold/filter could be set for 10 days subsequent.

In step 604, the system monitors for the triggering of the threshold.

If, in step 606, the threshold is not yet triggered, the system continues monitoring for the triggering in step 604. For example, the system could be configured to initially check after 10 days to see if the threshold has been triggered. If the $1 M excess did not persist for 10 days during that time, the threshold for alerting the risk event is not triggered.

If, in step 606, it is determined that a risk event has arisen and is to be alerted based on the threshold being triggered, the process moves to step 510, where the CA is directly alerted as to the risk event.

An advantage of the above process is the speed at which a maturing risk event is reported to the CA. Because the CM system of the present invention is configured to detect a risk event before it matures into a risk event to be alerted, the system need not wait until it receives updated facts from the originating branch concerning the client currency excess. Rather, according to the method of FIG. 6, the system is configured to automatically alert the CA as soon as thresholds are triggered (met), indicating that the detected risk event qualifies for alerting to the CA based on, for example, calculations and elapsed time. The CA can provide feedback to a MO to determine whether the facts at the time of the automatic alerting still support the classification as a risk event, and if so, appropriate steps can be taken.

In addition, the CM system of the present invention can be configured with more sophisticated filters/thresholds. In one embodiment of the present invention, the application of filters to a risk event is a two-step process. In the first step, a first filter is applied to determine whether a detected risk event is a “real” risk event as opposed to a “technical” risk event. In the second step, a second filter is applied to a “real” risk event, to determine if the “real” risk event is to be alerted, as described above. One example of a “technical” risk event involves a client having a money market account that matures on a first date. The client may request from a CA an extension for an additional month on the money market account, which does not create any real excess condition for that client, but may cause a technical excess to be detected by the system on the first due date before the account is updated. By appropriate choice of filters, the risk event detection system could be configured with a technical event filter to screen for such a technical excess, and thus delete the initially detected risk event from the system. Detected risk events that persist after going through a technical event filter are then deemed “real” risk events that may be alerted to a CA depending on the result of the application of a second filter.

In one embodiment of the present invention, technical filters (thresholds) can be improved based on\stored risk event data trails by identifying patterns in alleged real excess risk events that rarely result in true credit risks, and adjusting either the predetermined threshold reporting criteria or the criteria that separate technical excesses from real excesses.

In a further embodiment of the present invention, filters and thresholds are configured to change over time to adapt to changes that take place over time and differences between risk events. The CM system can, for example, provide separate filters and thresholds that may separately apply to each separate risk event type, and may accommodate changes as they arise.

In addition, the CM system can be configured to dynamically adjust alerting procedures to changing conditions. Typically, risk events can be set to be calculated on a daily basis. Once a deferral date is set for a newly determined risk event, a default condition can be set for the risk event to be alerted once the deferral date has approached. However, if the risk event deteriorates immensely from one day to the other, it is useful that the deterioration be alerted immediately, for example as an Action Required event (discussed further below) after the end of day processing. Some exemplary criteria that trigger immediate alerting to address this scenario are as follows: 1) if a collateral shortfall deteriorates from Warning to Margin Call, Close Out status or Unsecured status, or from Margin Call to Close Out or Unsecured status as well as Close out to Unsecured, the event is shown in the action required section. (Margin Erosion (ME exceptions) can be taken into account); 2) if a rise of minimum excess amount (for CS, LE, UNA) and/or ME %, set as parameter and defined for each location; 3) if Collateral Shortfall in unsecured status (i.e., ME=100% as ME>100% being capped at 100%) deteriorate as indicated by certain conditions (criteria deterioration of certain unsecured amount and possibly minimum deterioration of unsecured excess in comparison to a reference value).

In accordance with embodiments of the present invention, a CM system can distinguish various qualities associated with risk events including: 1) New risk events; 2) Action required risk events; 3) Risk events Pending CA (sent to CA and awaiting CAA/CA comment); 4) Risk events Pending Monitoring Assessment; 5) Deferred risk events (deferred manually by monitoring or automatically by system); 6) Risk events filtered due to a filter (automatically by system); 7) Risk events filtered due to a threshold (automatically by system); and 8) Closed risk events that can be stored as a function of each client.

Many other variations of the process steps illustrated in FIG. 5a are possible according to other embodiments of the present invention. For example, a set of specific rules can be established that guide how a CA, CO and MO interacts with client information, how the information related to alerted invents is stored and updated, and the manner in which the CA, CO, and MO can interact with the risk event information as it is developed within the CM system.

One set of exemplary rules according to another embodiment of the present invention is listed below.

1) The CA has access to her assigned clients. The MO and CO have access to all clients for certain locations (country or even region) in general.

2) The system changes the process status of each alerted event during the whole life of the risk event.

3) A log can be created automatically by the system every time the process status changes or a comment is saved, which is viewable in the client's risk event history.

4) If an event deteriorates as per rules described above, the event can be shown in an “action required” section even if the event was deferred to a later date, and the original deferral date will be updated to reflect the deteriorated status. All parties involved (MO, CA, CO) should be able to inform themselves about the status of open risk events at all times.

5) A risk event will be closed at the end of a day if an excess that caused the risk event no longer exists.

6) Once the CA or CO sends back an answer, the risk event can appear automatically in the MO's “action required” section for assessment/comment pending. It can be acknowledged by MO, with usually deferring the event to a later date for follow up, or reverted back to the CA if not approved in which case the event is captured again in the MO's CA/CO pending view. It is suggested that the CA propose a review (deferral date) that the MO can accept or overwrite.

7) Messages between the MO and CA/CO may be sent back and forth various times (i.e., no maximum limit set).

8) For reporting purposes, once a risk event response is sent back by the CA or CO and therefore an entry concerning the risk event appears in a Monitoring Pending Approval state within the “action required” view, the event should be classified as “processed.” This allows the MO to be measured through efficiency control on the processed events that are shown in the “action required” view by the beginning of the day.

9) If feasible, the system should be configured to allow future deadlines within the same day to be set.

10) All actions either taken by MO/CA/CO or the system itself can be logged with relevant data, e.g., commentaries, risk event status, age of events. The archiving periods of risk relevant information can be set according to other criteria.

11) Messages between the MO and CA/CO may be sent through a workflow tool or via other messaging means such as e-mail. The means of communication can be defined for each location.

12) Whether workflow tool or e-mail-only site, messages to the CA/CO can include a standard text format. Figures for all risk events of the same Partner (client) are sent within the same message, to comply with a customer-focused approach. The content of the messages plus relevant details on the event can be reviewed when detailing out the GUIs. Additional messages can be sent to allow the MO to reiterate an event with a message if the addressee has not answered.

13) Once the CA or CO sends a comment via a credit monitoring tool, the comments can be visible for all parties.

14) The CA can also be informed if the CO is requested to take action. Where required, the CO can comment on the risk event within the system, which in turn will be visible to the MO and CA.

In one embodiment of the present invention, the processes S and R outlined in FIG. 3 can be used in conjunction with each other to improve the quality of detection of risk events. For example, a first series of risk events could be processed using method R while a second series of risk events is processed using method S. The results of both sets of processes could then be compared. The results of such a comparison could then lead to a more efficient use and development of a better quality of the event risk monitoring system. In one particular instance, it might be determined that credit event risk processing for a first type of client is more successful using process S than for a second type of client. Client types could be distinguished by type of business, size of business, length of status as a client, or other criteria. In other words, for the first client type, the restoration of an OK status may be much easier in the case where the determined event risk is reported directly to a CA. For the second type of client, the automatic determination process using the risk event calculation engine might be subject to more problems, such that when directly reported to the CA, the resolution of the problem (return of the client account to OK status) takes longer, than for instance, if a human in the MO first reviews the determined risk event.

In light of the differences in outcomes between a first and second type of client, the CM system and process could then be refined to employ a Client Type filter that directs the second type of client through process R and the first type of client through process S, once the presence of a risk event is determined.

Other mechanisms for improvement of credit event risk management are possible. For example, because the CM system can be standardized and centralized, data mining can be applied to a large body of credit-risk-related data. Thus, differences in outcomes (for example, the time to resolution to OK status of a client account from the time of event risk alerting) could be searched on the basis of many different criteria. For example, it might be determined that both a first and second client type produce relatively acceptable results using process S, as opposed to process R. It might then be determined that neither client type merits using process R. However, it might further be determined that the results of client type two are inferior to client type one when using process S. The CA could then be flagged to direct more care in response to the MO to improve process S as applied to type two clients. The learning from MO/CA interactions with regards to the type two clients could then be incorporated in the CM system, for example, within thresholds, flags, or other criteria.

In further embodiments of the present invention, the CM system can be configured to generate alerts based on events other than risk event determination. For example, facility review/expiry can be automatically alerted to a CA; lending value and margin erosion exceptions can be alerted to a CO; maturing client structure links can be alerted to a CA; and special credit conditions can be alerted to Monitoring or a defined recipient for review.

As described herein, the system of the present invention further includes a reporting tool for analyzing technical excesses to provide feed back to improve the filtering and improve data quality. Those skilled in the art will appreciate that, because the time of the client advisor is very important, improving identification of excesses (risk events) and submitting only data of real excesses (not technical excesses) to the client advisor is very valuable.

The steps described herein are performed using general purpose information technology infrastructure that is programmed to function as described herein. Those skilled in the art will appreciate that the information technology infrastructure required to perform the steps herein includes, among other things, communications equipment, one or more databases for storage, and software engines and processors for performing the steps as described

In accordance with an embodiment of the present invention, instructions adapted to be executed by a processor to perform a method are stored on a computer-readable medium. The computer-readable medium can be a device that stores digital information. For example, a computer-readable medium includes a read-only memory (e.g., a Compact Disc-ROM, etc.) as is known in the art for storing software. The computer-readable medium can be accessed by a processor suitable for executing instructions adapted to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible.

Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. In a financial institution operating in a plurality of jurisdictions and holding loans against which collateral is pledged, the financial institution having access to data records storing information including a loan identification (ID), client ID associated with each loan ID, collateral associated with each loan ID, a client advisor associated with each client ID, jurisdiction information associated with each client ID, a method for credit monitoring comprising:
receiving information pertaining to the value of the collateral pledged against loans;
identifying credit risk events associated with the loans;
determining whether the credit risk events are real excesses or technical excesses and identifying real excess credit risk events;
analyzing the real excess credit risk events to determine whether the credit risk exceeds a threshold amount;
if the credit risk exceeds a predetermined threshold amount, then immediately reporting the real excess credit risk event to the client advisor associated with the client that is associated with the loan ID; and
if the real excess credit risk does not exceed the threshold amount, then storing the real excess credit risk event for future reporting to the client advisor associated with the client that is associated with the loan ID.

2. The method of claim 1, further comprising periodically monitoring the value of the collateral pledged against loans.

3. The method of claim 1, wherein the information pertaining to the value of the collateral pledged against loans is received from a source within the financial institution.

4. The method of claim 1, wherein the value of the collateral pledged against loans is monitored and reported to the financial institution in real time.

5. The method of claim 1, wherein the financial institution comprises a multinational financial institution.

6. The method of claim 5, further comprising:
storing in a central global data warehouse data identifying a client's assets in different jurisdictions of the multinational financial institution;
continually and automatically calculating the collateral value of the client's assets; and
determining the credit risk events based on the collateral value.

7. The method of claim 5, further comprising anonymizing the information pertaining to the value of the collateral pledged against loans to remove private client data before the information is received, and re-inserting the private client data in the report of the real excess credit risk event to the client advisor.

8. The method of claim 7, further comprising storing anonymized real excess credit risk events in a central database of the multinational financial institution and identifying patterns in the stored anonymized real excess credit risk events that indicate real excess credit risk events that should be reclassified as technical excesses.

9. A system for credit risk monitoring containing one or more hubs for storing and processing credit data from clients of a creditor, the credit data received from a plurality of local sources, the system further comprising:
an anonymizer linked to each of the one or more hubs for anonymizing data received from local sources;
a database comprising credit risk relevant data received from local sources;
a database for storing one or more of risk events, facilities, haircut overrides, client structure, third party business relationship assets, and monitoring rules;
a calculation engine for detecting a risk event based on the credit risk relevant data and preset rules;
a first set of thresholds/filters designed to determine if a detected risk event is a real risk event;
a second set of threshold/filters designed to determine if a real risk event qualifies for alerting; and
an event processor comprising a plurality of workflow tools, wherein the system is configured to store real risk events and to provide real risk events that qualify for alerting to one or more of the workflow tools for viewing by a client advisor.

10. A method for credit risk monitoring, comprising:
receiving anonymized local credit risk data concerning a first client at a central storage hub;
detecting one or more risk events based on the anonymized local credit risk related data and preset rules;
applying a first set of filters/thresholds to each detected risk event to determine if the detected risk event qualifies as a real risk event;
storing each real risk event in the central storage hub for review;
applying a second set of filters/thresholds to each real risk event to determine if the respective real risk event qualifies for alerting; and
forwarding a real risk event that qualifies for alerting to a client advisor.

11. A method for credit risk management, comprising:
determining that a risk event associated with a creditor client exists based on local credit risk related data stored at a central hub and a set of credit risk criteria for a set of clients;
determining that the risk event qualifies as a real risk event based on a first set of thresholds/filters;
determining the real risk event qualifies for alerting based on a second set of thresholds/filters;
automatically forwarding alerting the real risk event to a client advisor associated with the client;
receiving input from the client advisor at a monitorer of the creditor;
setting a deferral date for closing the alerted risk event; and
closing the alerted risk event on the deferral date if it is determined that the alerted risk event no longer persists.

12. In a financial institution operating in a plurality of jurisdictions and holding loans against which collateral is pledged, the financial institution having access to data records storing information including a loan identification (ID), client ID associated with each loan ID, collateral associated with each loan ID, a client advisor associated with each client ID, jurisdiction information associated with each client ID, a credit monitoring system comprising:
information technology infrastructure for receiving information pertaining to the value of the collateral pledged against loans;
information technology infrastructure for identifying credit risk events associated with the loans;
information technology infrastructure for determining whether the credit risk events are real excesses or technical excesses and identifying real excess credit risk events; and
information technology infrastructure for analyzing the real excess credit risk events to determine whether the credit risk exceeds a threshold amount, wherein if the credit risk exceeds a predetermined threshold amount, then immediately reporting the real excess credit risk event to the client advisor associated with the client that is associated with the loan ID, and if the real excess credit risk does not exceed the threshold amount, then storing the real excess credit risk event for future reporting to the client advisor associated with the client that is associated with the loan ID.
